(19) United States
(12) Patent Application Publication
(10) Pub. No.: US 2010/0022270 A1
(43) Pub. Date: Jan. 28, 2010

(54) Mobile dialogue system and mobile content delivery solutions

(76) Inventors: John Mikkelsen, Minneapolis, MN (US); Robert Freidson, St. Petersburg (RU)

Correspondence Address: John P. Luther;Ladas & Parry LLP, 224 South Michigan Ave., Suite 1600, Chicago, IL, 60604, US

(21) Appl. No.: 12/456,343

(22) Filed: Jun. 15, 2009

Related U.S. Application Data
(63) Continuation-in-part of application No. 12/322,537, filed on Feb. 4, 2009.
Application No. 12/322,537 is a continuation-in-part of application No. 10/183,756, filed on Jun. 26, 2002, now Pat. No. 7,548,875.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.

(51) Int. Cl. H04M 1/00; G06K 7/10

(52) U.S. Cl. 455/556.1; 235/462.01

(57) ABSTRACT

This invention relates to a method, system and products for the transmission, delivery, playback, and content management of audio and visual files for wireless and non-wireless devices, and a new Internet-less protocol for such transmission to portable electronic devices, such as cell phones and the like.

### RELATED APPLICATIONS

This application is a continuation-in-part of the U.S. Ser. No. 12/322,537, filed Feb. 4, 2009, which is a continuation-in-part of Ser. No. 10/183,756, filed Jun. 6, 2002, now U.S. Pat. No. 7,548,875, which claims priority to U.S. Provisional Application Ser. No. 60/301,681, filed Jun. 27, 2001, U.S. Provisional Application Ser. No. 60/303,115, filed Jul. 3, 2001, U.S. Provisional Application Ser. No. 60/312,450, filed Aug. 14, 2001, and U.S. Provisional Application No. 60/343,159, filed Oct. 26, 2001, all of which applications are incorporated by herein reference.

### FILED OF THE INVENTION

This invention relates to a method, system and products for the transmission, delivery, playback, and content management of audio and visual files for wireless and non-wireless devices, and a new Internet-less protocol for such transmission to portable electronic devices, such as cell phones and the like.

### BRIEF DESCRIPTION OF DRAWINGS

FIG. 1 Mobile Shopping Search Engine and Buying Guide

FIG. 2 Travel Reservation Scenario

FIG. 3 Mobile Stock Trading Scenario

FIG. 4 Multimodal Dialogue System Architecture

FIG. 5 Server Side Architecture

FIG. 6 Client Side Components

FIG. 7 Information Flow

FIG. 8 Communication Flow

FIG. 9 Horizontal Service Oriented System Components

FIG. 10 Content Management System

FIG. 11 Content Discovery and Delivery System

FIG. 12 Dual-processor System for Mobile Multimedia Applications

### DETAILED DISCUSSION OF PREFERRED EMBODIMENTS

Considered herein are various approaches for mobile communication system designs that capitalize on the efficiency of telephone-initiated protocol, such as disclosed in co-pending application Ser. No. 12/322,537, filed Feb. 4, 2009 which is incorporated by reference herein, and the advantages of the different input/output mechanisms working in tandem instead of being constrained by their limitations.

Critical to bringing the benefits of mobile devices to mass business markets is a more natural way of communicating. The application of the present examples or “M.800 Mobile Dialogue Systems” enables users to provide different inputs via voice, keyboard and even graphic or video.

For example, often listening to instructions, customers may wish to listen to the instructions again. Multimode interfaces provide the flexibility to choose the most convenient interaction mode that suits the task and purpose.

M.800 Mobile Dialogue Systems also includes Mobile Download Manager Server which is a powerful content delivery solution that provides a superior end-user shopping experience. It manages the purchase, packaging and delivery of all types of downloadable content-including Java™ applications, ringbones, games, images and more to mobile devices.

Subscribers have access to the entire content catalog in a single view. This single view allows content providers to consolidate content into a single bundle. Subscribers can browse, select, purchase and download any type of content, from one intuitive and easy-to-use interface, viewed either from their WAP or Web browser.

Download Manager provides users with a direct access to new or existing content and services with one-click purchasing and always up-to date content. The content list is updated to the handset automatically when a customer opens the content list on customer's mobile phone.

M.800 Mobile Dialogue Systems are set to grow in importance in the coming years, bringing benefits to m-businesses and end-users. With the growing popularity of mobile handled devices mobile information access and remote transactions are fast becoming commonplace.

Business Value

M.800 Mobile Dialogue System improves the usability of most mobile services such as Mobile Shopping, Buying Guides, Mobile Product Catalogs, Mobile Directories, Personal Information Management, and unified messaging. Application Service Provider can offer a wide range of personalized and differentiated offerings using Mobile Dialogue interfaces. Call center applications and enterprise data services; such as account management, brokerage accounts, customer service, and sales force automation offer voice-only interfaces. With Mobile Dialogue interfaces, one can easily access and enter information, especially when using small devices by combining multiple input and output device.

Other Advantages

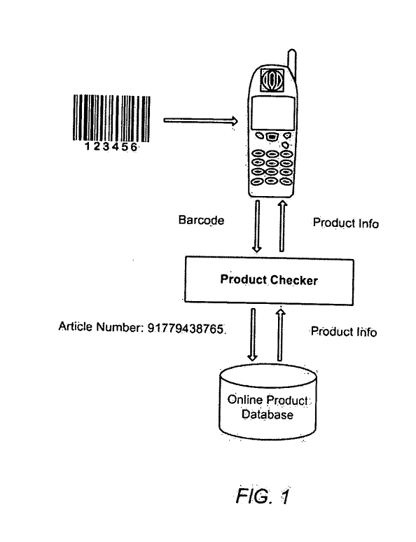

Mobile Shopping Applications based on Mobile Dialogue System allow shoppers to search and compare Online Product Information by their barcode or pictures, obtain product identification and research product information before making an in-store purchase. Mobile Buying Guides and Product Catalogs may reserve an item in a store, while one goes home in order to make more detailed online research, as shown in FIG. 1. M-Commerce with Mobile Dialogue Systems may improve customers' experience with mobile devices and encourage the growth and acceptance of m-Commerce.

Application Scenarios

Scenario 1. Mobile Smart Shopping

Real-Time Video-based Product Identification and Personalized Product Checker.

Mobile Dialogue Product Checker allows shoppers to search and compare Online Product Information by their barcode, video or picture, obtain product identification and research product information before making an in-store purchase. Mobile Shopping Search Engine and Buying Guide will reserve an item in a store while one goes home in order to make more detailed online research, as shown in FIG. 1.

Scenario 2. Travel Reservation. Voice+GUI (Graphic User Interface)

Display seat selection chart (not simply “window or aisle”;

Use voice or keys to enter PIN code and performs speaker verification;

Use audio or voice for notifications;

Information can be saved for later use.

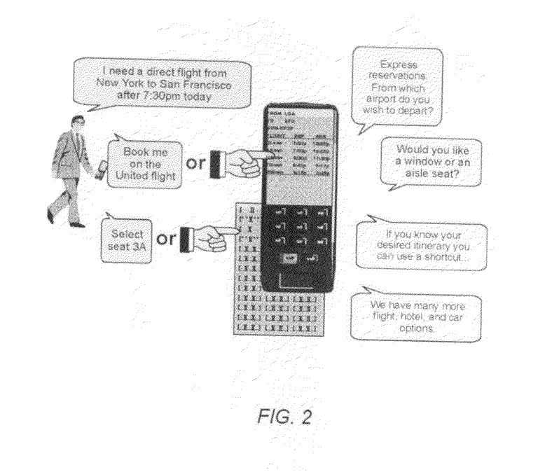

This scenario is shown in FIG. 2.

As shown, a user is not tied to a particular channel's presentation, and flow interaction becomes a personal and optimized experience. Such multimode output is an example of multi-media where the different modalities are closely synchronized.

Scenario 3. Mobile Stock Trading

This example demonstrates how your experience is more natural and personalized, as one is able to capitalize on the ease of voice input and also view detailed information on a visual display in the same session.

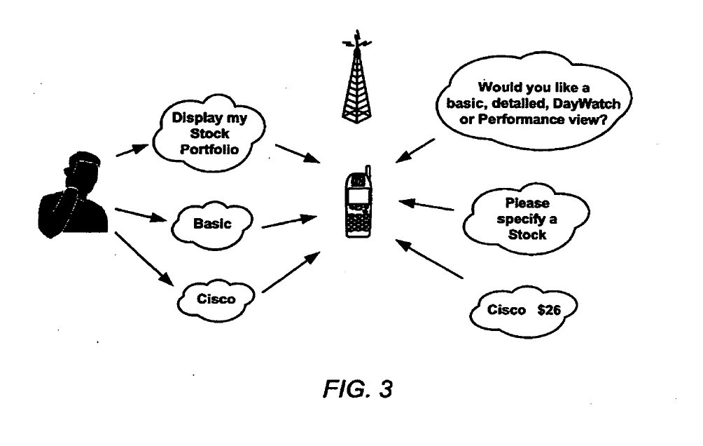

This scenario is shown in FIG. 3.

Additional features such as speaker verification, interactive displays of visual information (e.g. charts), audio/video notification, etc. can make the interaction more natural. One is not restricted to a particular user interface, but is able to exploit the advantages of multiple synchronized interfaces.

System Architecture

An example system may have Server-Client architecture. The client portion may comprise basically two parts:

The input part that sends user interactions to the server, such as voice, text, pictures and video input, and an output part that presents the results received from the server.

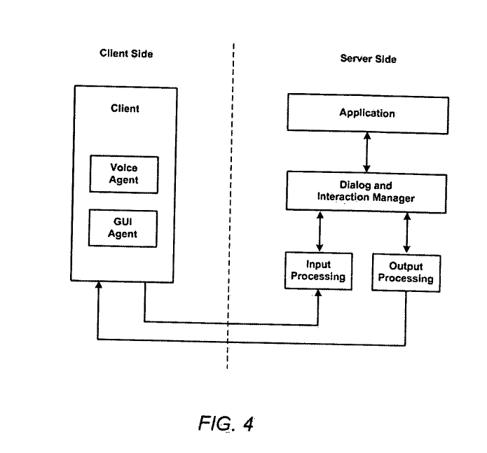

The server side may comprise different modules performing system critical tasks. A FIG. 4 illustrates, the server may have an input part which collects different input from the user and forwards it to a Dialog and Interaction Manager (DAIM). The DAIM module processes the input and interacts with the application special module to generate a result to the user. The result can be forwarded to the output module that makes the result of the user query presentable in the form most suitable.

Server Side

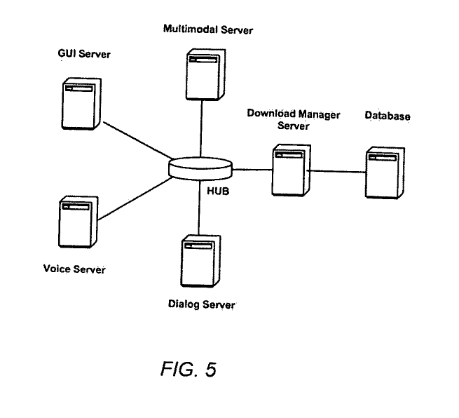

The server part of system may comprise in a preferred embodiment five main autonomous modules (or servers), or more (not shown), that communicate via a central facilitator module, called a Hub, illustrated in FIG. 5. The different server modules need to communicate with each other to perform certain tasks. To handle these messages a Hub is implemented. The Hub conveniently provides modularity to the system.

Messages are distributed between server modules according to certain rules based on the service logic.

The messages are usually asynchronous which means that the modules cannot expect to receive a response immediately. A module requiring certain functionality may pass this job to the Hub, and the Hub will then know which module to forward the request to. This makes up the properties modularity, distribution and seamless integration of modules which constitute the Hub.

Voice Server

The Voice Server is the module that handles the voice modality. Interaction is handled both ways. For example, speech input from the user can be interpreted by the ASR (Automatic speech recognition) module and voice output from the system to the user could apply the TTS (Text-To-Speech) module to construct synthesized voice.

The Voice Server can support both packet-switched and circuit-switched voice transmission. The packet-based version is a VoIP solution. It simply copies the audio input and converts it to standard PCM format and transfers it over a TCP/IP socket connection between client and server.

GUI Server

The GUI server handles the visual modality meaning graphics and text output to the user and the input received from the user, respectively. It acts as the gateway between the client and the other server modules. Input from the user is received and forwarded to the Dialog Server via the Multimodal Server. Based on feedback from a user query, the video, graphics and text presenting the result is handled by the GUI server. The GUI server uses a web server to display the graphics and text.

Download Manager Server

The Download Manager Server may be assigned to update and manage the customer's content list and to update new services and information at customer's handset over the air. The server-side application creates a content list for download and storage to a customer's cell phone and supports a direct correspondence between a web site and cell phone for the purpose of storing and delivering any data bundles fast and efficiently in one cost effective package.

Download Manager provides users with a direct access to new or existing content and services with one-click purchasing and always up-to-date content. The content list is updated to the handset automatically when a customer opens the content list on customer's mobile phone.

Dialog Server

The Dialog Server module also called Dialog Manager is another important and preferred part of the system. The Dialog Server receives the user query from the Multimodal Server. Based on these inputs, the Dialog server extracts the meaning of the user interaction. Further, the Dialog Manager interacts with the Database Server to generate an answer to the user query. The last step is to present the query response and transfer the information to the user comprising speech, graphic and video.

Database Server and Database

The Database Server is application specific and should be as general as possible to support all kinds of applications. The Database Server acts as a connecting link between the Dialog Server and the Database.

Client Side

Basically, the Multimodal Client comprises a Voice Client and a GUI Client, both incorporated in a stand alone software product. For example, this software can be developed for the Windows Mobile platform such as Microsoft Windows Mobile 5.0 or higher.

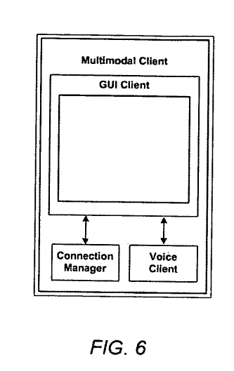

FIG. 6 shows a logical overview of the different components that the Client consists of namely the Connection Manager, GUI Client and Voice Client.

The Connection Manager provides an interface between the Voice Client, GUI Client and via the network consequently with the Multimodal Server. The client communicates with the server using P2P.

The Voice Client handles the voice modality, i.e., it receives and forwards voice commands from the user and output synthesized voice from the Multimodal Server.

The GUI Client is somewhat more complex. It consists of a web browser, which retrieves web pages containing the graphical user interface and consequently the application provided. It also handles other available input from the user, i.e., when a user points on an icon on the web page, the coordinates of the pushed icon is collected and transferred to the Multimodal Server as user inputs and handled thereafter.

Information and Communication Flow

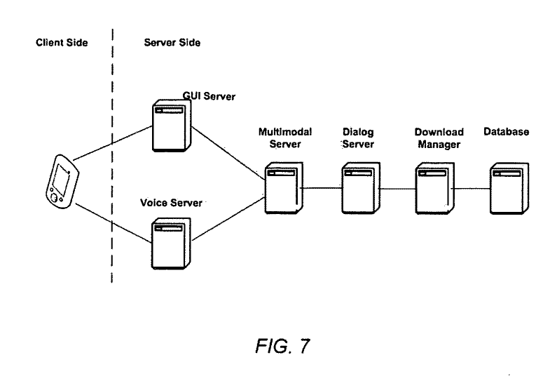

FIG. 7 illustrates interaction patterns between user, client and server and the information flow between the modules of the system.

The information flow is based on user queries. These inputs are transferred to their respective server modules. The GUI server registers where the user has pointed and the voice server performs DTMF or voice recognition and extracts the essential meaning of it. Next these inputs are handed over to the Multimodal Server, which employs a timer mechanism to collect input signal within a specified time window.

Further, when the time window expires of the Multimodal Server has received a maximum of simultaneous inputs it passes these inputs to the Dialog Server. The Dialog Server competes the multimodal integration and based on this process, it will try to create a response to the query. To elaborate a response, the Dialog Server can query the Database Server. The Database Server performs a lookup in the Database and returns the result back to the dialog module.

The result is then processed by the Dialog Manager to create a presentable response to the user. The response is passed over to the Multimodal Server, which splits the information into different modalities, i.e., graphics and speech, which are sent out via the GUI and Voice Server respectively.

FIG. 7 shows that the Client needs to set up two logical channels between Client and Server. One channel for transmission of the voice modality and another channel for data.

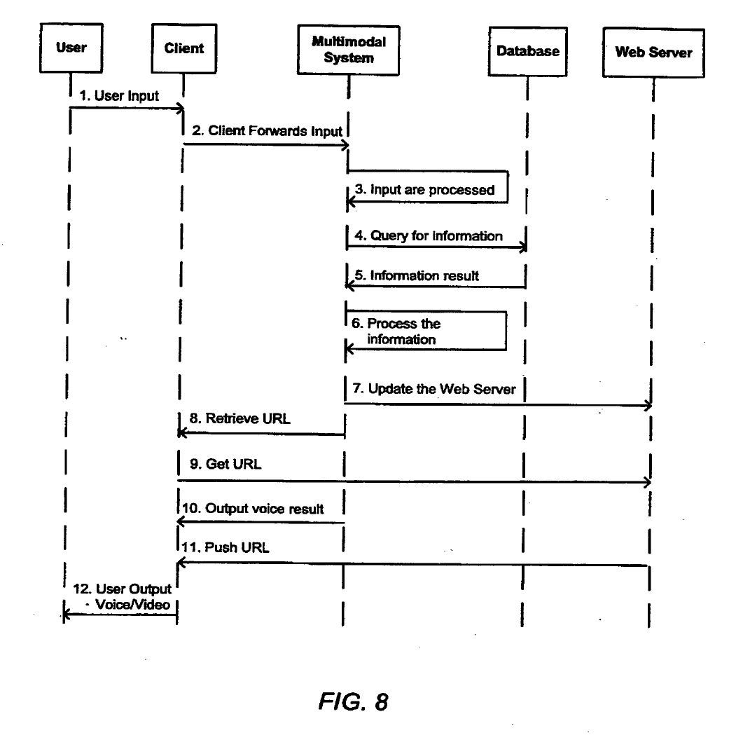

The communication between client and server is detailed in FIG. 8. Steps 1 to 6 have been described above. At step 7, the Multimodal Server creates a web/wap page that is uploaded to a web/wap server. At the same time, a message is sent to the Client's software telling it to download the web page at the given URL. The client which has an embedded web browser send a standard HTTP request to retrieve the web page created. At step 10, the Multimodal System transfers the voice response elaborated from the result of the user query. Preferably in the same moment, the web page presenting the visual modality of the result is displayed at the client. The synchronization of these two outputs is as crucial for the user experience as the synchronization of the user input.

Preferred System Requirements

Preferred requirements for a mobile multimodal client-server system are now set out. The example set out above present different situations and different needs that people may have and a Multimodal System can provide service for. Based on these scenarios, requirements are focused on both functional and performance requirements:

The multimodal platform is preferably a generic platform with a possibility to implement an array of services on top of it.

The multimodal platform preferably allows third party service providers to offer their services over the mobile operator's multimodal platform.

The client part of the multimodal system is advantageously simple, requiring minimal installation for the user on the terminal

List of Preferred Requirements

### Requirement Description

TABLE 1
Preferred Requirements for the Multimodal System

| | |
|---|---|
| R1 | The system is preferably available over a ubiquitous mobile |
| | wireless network |
| R2 | The mobile network supports simultaneous transmission of real- |
| | time voice and data |
| R3 | The transmission of voice maintains the audio quality |
| R4 | The system is effective to receive simultaneous inputs |
| R5 | The multimodal system handles the characteristics that the |
| | infrastructure provide, i.e. delay, data rate, etc. |
| R6 | The user is able to user the different input channels to the |
| | multimodal interface according to user preferences. |
| R7 | The system presents the results of a user query based on user |
| | preferences. |
| R8 | The multimodal system is able to attract all kinds of people and |
| | users |
| R9 | The multimodal system provides services that are responsive |
| | and intuitive |
| R10 | The services provided over the multimodal platform are easier to |
| | user that services applying conventional interaction methods |
| R11 | The multimodal system is based on open standards |
| R12 | The multimodal platform is preferably generic making it |
| | possible to implement different kinds of applications on top of it |
| R13 | The multimodal platform supports a system interface and API |
| | that allow third party service providers to offer their services |
| R14 | The client part of the multimodal systems is advantageously |
| | simple to implement, requiring minimal intervention from the |
| | user. |

Combining Multimodalities

Multimodality in the context of this invention means the user of more than one Modality. This means that a user is preferably able to use more than one mode when giving input to a service. In the same manner the system is preferably able to give output to the user using more than one modality. The definition of multimodality is not meant to set any restrictions on whether the modalities are applied simultaneously or sequentially.

The World Wide Web consortium (W3C) has defined three different ways of combining multimodal inputs and outputs; sequential, uncoordinated simultaneous and coordinated simultaneous multimodal input/output. It is advantageous to distinguish these three scenarios because the complexity of their implementation is very different.

Sequential Multimodal Input/Output

This is the simplest form of multimodal interaction, where input and output from different modalities are interpreted separately but at any given moment only a single, designated input mode is active.

Uncoordinated Simultaneous Multimodal Input/Output

In this situation several parallel input modes are active at the same time. This means that the users can choose the input mode they prefer at each dialog stage, but in turn only one is selected for processing. Which mode is used at each turn can be decided according to different criteria, such as the first mode to start or that one mode has priority over the other.

Coordinated Simultaneous Multimodal Input/Output

This is the most advanced form of interaction. Also here more than one input mode is available simultaneously, but in contrast to the uncoordinated simultaneous mode, here all inputs from the different modalities are collected within a time window and interpreted. In the coordinated simultaneous mode the events are combined to create a query to the Multimodal System.

Simultaneous Circuit-Switched and Packet-Switched Connections

In recent years, new promising methods have been discovered which could enable simultaneous circuit and packet-switched connection for GSM networks.

TABLE 2
GPRS Classes

| Classes | Description |
|---|---|
| Class A | The terminal can be simultaneously connected |
| | to both a GPRS service and a GSM service, i.e., |
| | a packet-switched and circuit-switched |
| | connection respectively. No such devices are |
| | known to be available today. |
| Class B | The terminal can be connected to both a GPRS |
| | service and a GSM service, but only one at the |
| | time. During GSM service, GPRS service is |
| | suspended, and then resumed automatically |
| | after the GSM service is finished. Most GPRS |
| | mobile devices are class B. |
| Class C | The terminal is connected to either GPRS |
| | service or GSM service. The terminal must be |
| | switched manually between the two |
| | connections. |

This technology is called Dual Transfer Mode (DTM) and much research has been put into the topic. The method does not require two radio-transceivers, making it more rational and cost-effective. In UMTS, due to the radio interface used, it is fairly easy to implement support for multiple, parallel bearers over the air interface. This enables simultaneous circuit and packet-switched connections. UMTS equipment is able to work in different modes of operations, see Table 3.

TABLE 3
UMTS modes of operation

| | Description |
|---|---|
| Packet/Circuit | The MS is attached to both the PS domain and CS |
| sitched mode | domain, and the MS is capable of simultaneously |
| | operating PS services and CS services. |
| Packet- | The MS is attached to the PS domain only and may only |
| switched mode | operate services of the PS domain. However, this does |
| | not prevent CS-like services to be offered over the PS |
| | domain (like VoIP). |
| Circuit- | The MS is attached to the CS domain only and may only |
| switched mode | operate services of the CS domain. |

Mobile Operating Systems

There are several mobile terminals with different operating systems and connection options in the market today. New so-called smartphones and the convergence between PDA's and mobile phones result in highly advanced terminals, capable of doing complex tasks.

There are mainly two OS' that appear to be dominant of mobile terminals. Symbian, which is owned by Nokia, Sony Ericcson, Panasonic, Siemens AG, and Windows Mobile, which is provided by Microsoft.

Until just recently, the Symbian OS was the dominant operating system for advanced mobile terminals. This is because some of the world's biggest mobile phone manufactures such as Nokia, and Ericcson are using the OS in their smartphones. Despite the user of the same platform, every manufacturer uses their proprietary graphical user interface. When Microsoft decided to move into the mobile terminal market, it was obvious that they would be a strong competitor. Most PC users are familiar with the Windows OS. It is natural that many users would like to have the same interface and access to the same services and applications on their mobile terminal.

The release Windows Mobile 6 comes into different versions, one version call Smartphones and the other called PocketPC. The main difference between these versions is that they are fitted to two different types of advanced mobile terminals. The Smartphone edition is more like a regular mobile phone with a keypad and a screen. The Pocket PC version is developed for PDA's with a touch-sensitive screen.

Mobile Content Delivery Solution

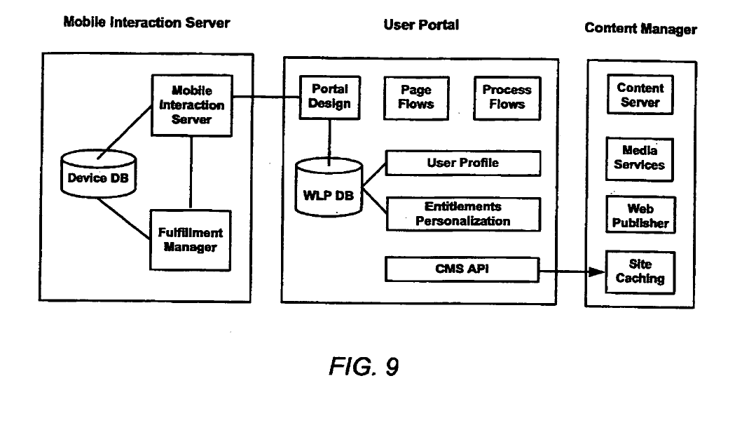

Modern Mobile Content Delivery Solutions utilize a horizontal Service Oriented Architecture approach. FIG. 9 illustrates typical System components.

Preferred System Components

Mobile Interaction Server (MIS): providing device recognition optimal device rendering of discovery portlets and maintaining profiles of devices and the digital media formats they support.

Fulfillment Manager: providing delivery of downloadable content across a range of access channels by determining the appropriate download mechanism based on content type and target device and subsequently ensuring completion of the download itself.

User Portal: framework for discovery of available content and the facilities to enable rapid integration with an operator's existing billing and messaging platforms.

Content Management System: Providing full content lifecycle management from submission and acquisition, to cataloging and verification, to publishing and eventual retirement of digital media.

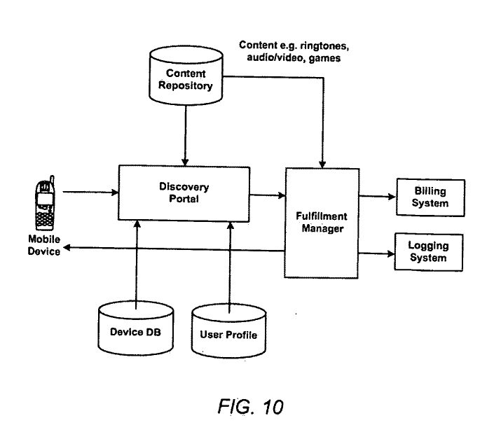

The functionality provided by the inventive system is illustrated in FIG. 10.

Content Discovery and Delivery takes place within the context of the User Portal environment where end-users access and utilize services and content offered by an operator.

Content Management takes place within an operator's administrative environment where Content Providers work with the operator to manage the submission, approval, and publication of content to the User Portal environment.

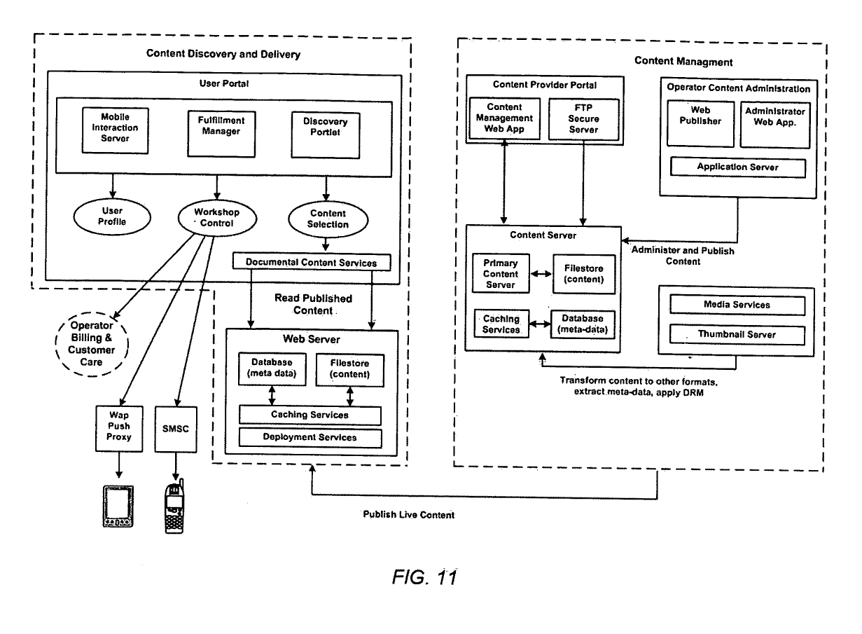

The functionality provided by the individual components, as well as the integration and interaction with other components in a typical operator environment are described in more detail below with reference to FIG. 11.

Content Discovery & Delivery in the User Portal Environment

The User Portal provides end-users with access to a set of available services based on their service subscription, configured preferences, and the capabilities of the device they are using to access the User Portal. The User Portal dynamically generates a tailored view of the end-user's available services by recognizing the user's device, accessing the user's service subscription profile and appropriately rendering subscribed services based on the device capabilities. The User Portal allows end-users to access services from a range of devices, including PC browsers, PDA browsers, WAP and Cell Phone browsers, etc.

Among the services offered within the User Portal are content download services such as ringtone downloads, wallpaper downloads, java game downloads, music and video downloads, etc. These download services are implemented as “portlets” within the User Portal, enabling end-users to ‘discover’ content that is available for download to their device and subsequently initiate the purchase (if applicable) and ‘delivery’ (download) of the content to their device.

Content Discovery

The individual content discovery portlets leverage the device-aware framework provided by the User Portal to ensure that only content appropriate for an end-user's device is presented as available for download. For example, polyphonic ringtones would only be shown in the discover portlet when the end-user's device supports them. The discovery portlets also leverage the multi-channel device rendering functionality of the User Portal to ensure optimal presentation and user interaction with the portlet itself.

The Content Delivery Framework integrated within the User Portal provides discovery portlets with additional generic capabilities that enable the content discovery process, including:

An interface for querying and identifying available published content based on device characteristics, specific content formats, keywords, service association, etc.

An interface that enables retrieval of pricing information to present to end-users.

The ability to initiate delivery of the content itself once discovery completes

Content discovery portlets typically leverage the ability to query the published content to enable discovery of content in one of two ways: 1.) End-users are presented with a series of menus and navigate their way through selected categories of content until they find a particular piece of content they are interested in. These menus are dynamically generated by the discovery portlet, ensuring the end-user is only presented with content choices that have been filtered based on the capabilities of the end-user's device. Menus of content can be organized and presented by category, by format, by popularity, etc.; and 2.) End-users are presented with a list of available content matching the search criteria. Again, the content is filtered based on the capabilities of the end-user's device.

In fact, the user experience during content discovery may vary greatly depending on the implementation of individual discovery portlets, the desired business models employed by the operator and the capabilities provided by the operators underlying network itself. Further, end-users may be offered the ability to preview or sample content prior to initiating deliver of a full version of the content, and end-users may be offered alternative pricing options depending on the content type and the operator's chosen business models e.g., free, unlimited ringtone downloads for a flat monthly rate, 10 wallpapers for 5$, individual java games for 2$ and additional levels for a game at $0.25 each, etc.

Network capability restrictions may make it impossible to offer pre-paid downloads, offer delivery of content using WAP Push, or offer the ability to discover content for other end-users.

The discovery portlets themselves are preferably designed to ensure a simple and compelling user experience.

Content Delivery

Once an end-user completes the content discovery process and confirms that delivery of the content should proceed, the delivery process is initiated. Delivery of the selected content may depend largely on the type of content the end-user has requested; the capabilities of the end-user's device; and the manner in which the content has been discovered.

For example, if discovery was completed using the same device that the content is to be delivered to, the content can be delivered directly within the same session by redirecting the end-user's browser or application manager to pull in the content. Alternatively, the content can be sent separately to the end-user's device using a mechanism such as WAP Push.

The User Portal containing the Content Download service is not discussed. The Mobile Interaction Server is deployed within the User Portal framework to provide device recognition and optimal rendering of the User Portal and associated services across a range of devices.

The User Portal framework is integrated with various elements within an operator's deployment environment so that they can be leveraged during content discovery and Delivery. Typically, the User Portal is integrated with the operator's Short Message Service Center (SMSC) and WAP Push Proxy Gateway (PPG), prepaid and post-paid billing platforms, and the operator's provisioning and customer care platforms. The User Portal is also integrated Content Management System.

Fulfillment Manager

Within the Mobile Content delivery framework, the Fulfillment Manager facilitates the content delivery process. It ensures the end-user requesting the download is authorized to download the content, determines the appropriate download mechanism to be used, based on the content and target device, and ensures completion of the download itself.

It interfaces to billing and statistical generation components to enable confirmation of billing and ensure tracking of download and also handles installation reports from J2ME devices, when appropriate.

The business logic within the Fulfillment Manager can be customized to align with operator business models. For example, billing confirmation can occur prior to delivery of the content or can occur only following completion of the download. The business logic may also vary between pre-paid and post-paid subscribers.

The Fulfillment Manager is usually based on the J2EE Client Provisioning standards. It provides an abstract adapter model for provisioning a number of content types and supports a number of provisioning models. The Fulfillment Manager facilitates delivery directly to the discovery device and also supports PC based discovery by enabling delivery to a device using WAP Push facilities available from the operator's network.

The Fulfillment Manager provides specific adapters for MIDP OTA and OMA OTA, provides a generic download adapter to handle all other downloads e.g. direct download of images, audio files, etc., and can be easily extended to support additional adapters as required.

Content Management

The Mobile Content Delivery System leverages the core components of the Content Management Suite:

Content Server: stores the content submitted by Content Providers and subsequently published to the Site Caching Services.

Caching Services: stores published content that is available for download from discovery portlets in the User Portal. As associated database stores meta-data describing the content stored in the Site Caching Services as well as content that is physically hosted by external Content Providers.

Content Services: an interface to the meta-database allowing discovery portlets to use a content connector to search available published content for specific content appropriate to present to the end-user for possible download.

WebPublisher: a tool used by content administrators to manage the lifecycle of content. Processes are modeled as customized workflows that enable content to be submitted, categorized, approved, published and, if appropriate, retired. A meta-data object model is used to fully describe the content, enabling publication for discovery and download. The meta-data describes basic details about the content itself, such as type of content, format and size, as well as descriptive information, such as artist, title, and category, allowing individual discovery portlets to effectively use the content services interface to filter content for presentation to end-users.

Media Services: provides automatic replication and transformation of submitted content into alternative formats and sizes, performs automatic meta-data extraction, and provides an extensible plug-in framework enabling integration of DRM toolkits, graphics services, etc.

Content Provider

To facilitate content submission by external Content Providers, a Content Provider Portal can be deployed in the operator's administration environment. The Content Provider Portal provides an interface, such as a content management web application and/or an FTP server that can be used by content Providers to submit and update content to the Content Server. Using a web application, Content Providers would fill in web-based forms describing the content essentially the meta-data schema and then upload the content to the Content Server. Using an FTP server, Content Providers would upload the content and an XML file describing the meta-data for the content.

Preferred Wireless Device Requirements. Dual-Processor Architecture

In U.S. Pat. No. 7,548,875 a wireless communication device with Multimedia DSP Subsystem is described. This dual-processor architecture is very well suited to process the most demanding multimedia applications, including real-time video processing. The architecture has been significantly enhanced and optimized by utilizing a low-power, programmable DSP and a powerful RISC (Reduced Instruction Set Computing) general-purpose processor.

Because of the demands of applications, a partitioning of the application's tasks between the two processors is critical. The speed and throughput of the system should be optimized when tasks are assigned to the processor best suited to handle them. Optimal assigning tasks to the appropriate processor will reduce the number of processor cycles required for each task, which, in turn, reduces the power drained from the battery and extends the usable life of the mobile device.

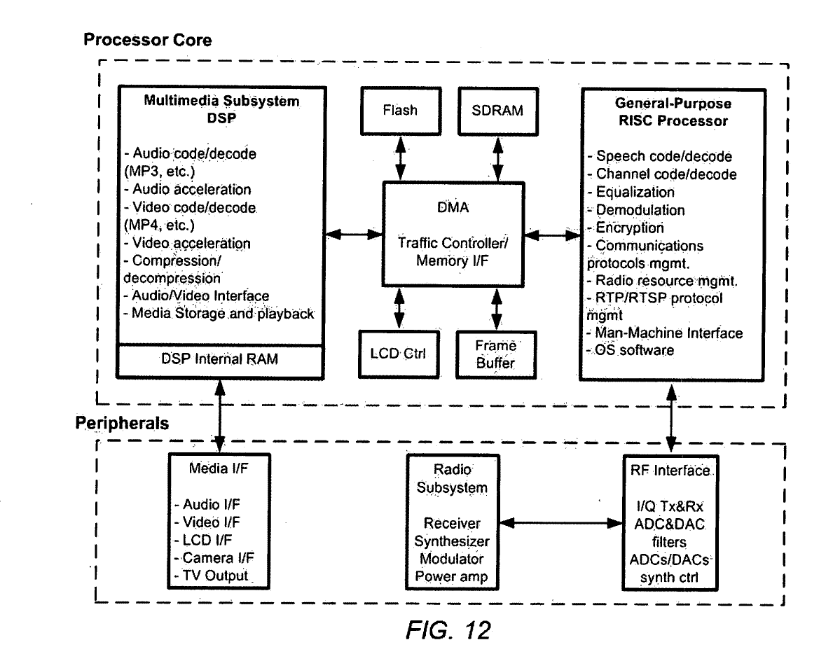

FIG. 12 shows an efficient way to map a mobile video application onto the dual-processor architecture that optimized to provide the processing capabilities needed for demanding wireless multimedia applications and, at the same time, extend the battery life of mobile devices by consuming less power.

The tasks involved in a mobile video application can be divided into control, transport, and media decode. Control and transport tasks include processing the Real-Time Streaming Protocol (RTSP) and the Real-Time Protocol (RTP), which is a media transport mechanism. Because these tasks are not computationally intense, a general-purpose RISC processor is well suited to executing them.

Media decode tasks involve decoding the video bit stream, high quality audio decoding and other signal processing tasks. These processes are computationally intense. As a result, a high-performance, low-power DSP is a good fit for media decode tasks.

When a video application is processing, radio signals enter the system by way of a modem. The general-purpose RISC processor handles the RTP/RTSP protocol processing and demultiplexes the audio and video data. The radio signals are then transformed into an elementary bit stream and forwarded to the DSP's internal random access memory (RAM).

To minimize the processing demands on the system, video applications use the current frame or image to extrapolate the following frames. A frame is moved one macro-block at a time from the frame buffer into the DSP's internal RAM where it is combined with other information and sent to the display as the current frame.

The processing capabilities of the two processors would be wasted if data could not be moved throughout the system in a timely fashion. Direct Memory Access (DMA) connections are used to avoid I/O bottlenecks, which can disable a video application. All of the DMA channels have access to all of the shared memory, ensuring an efficient internal data flow. The DMA capabilities are needed to speed the movement of data structures because large graphic images must be quickly and constantly moved from external memory to internal memory.

Dual-processor architectures raise the question of conflicts between processors which can arise when both processors contend for the same memory location. In addition, memory access requests initiated by either of the two processors for a certain location in memory can be processed only one at a time. The system is able to overcome contention between the processors because of the Traffic Controller, which is an inherent part of the architecture.

The Traffic Controller is a programmable arbitration mechanism that sits between the DSP, the general-purpose RISC processor and the external interfaces. Depending on the algorithms programmed into the Traffic Controller, it will prioritize memory accesses and resolve any conflicts that may arise.

Error correction. Besides regular error resilience tools that are built into the modern compression standards like MPEG-4, the post-processing technique is engaged in the system. This technique follows the video decoding process and replaces corrupted macro-blocks with the uncorrupted macro-blocks from the previous frame, making use of data that has been recovered through the error resilience tools previously mentioned.

Error correction process places a strain on a device's I/O channels, because these tools and technique often require that the processor re-examines past frames to extrapolate more accurately the current frame. Large blocks of data are flowing back and forth between the DSP processor's external memory and its on-chip RAM. The system is able to overcome it because of many DMA channels, which diminish the likelihood that I/O will become a bottleneck.

Glossary of Terms

| | |
|---|---|
| CMS API | Content Management System Application Programming |
| | Interface |
| DB | Database |
| DC | Delivery Context |
| DRM | Digital Rights Management |
| FTP | File Transfer Protocol |
| J2ME | Java 2 Platform, Micro Edition |
| JSP | Java Server Page |
| OMA | Open Mobile Alliance |
| MMS-C | Multi-Media Message Service Center |
| PORTLETS | User Interface Components Managed and Displayed in a |
| | Web Portal |
| PDA | Personal Digital Assistant |
| SCP | Service Control Point |
| SDP | Service Delivery Platform |
| SMPP | Short Message Peer-to-Peer Protocol |
| SMS-C | Short Message Service Center |
| WAP | Wireless Application Protocol |
| WAP-GW | Wireless Application Protocol Gateway |
| WPPG | WAP Push Proxy Gateway |
| XML | Extensible Markup Language |

A preferred method and system for use with present invention is that disclosed in co-pending U.S. patent application Ser. No. 10/153,756, filed Jun. 26, 2002, entitled “Media Delivery Platform”, new U.S. Pat. No. 7,548,875 which is incorporated by reference herein in its entirety.

1. A bar code reader which transmits item and purchase information via digitally compressed data content to a receiver.

2. The bar code reader which is a cell phone.
